(19) United States
(12) Patent Application Publication
(10) Pub. No.: US 2017/0026474 A1
(43) Pub. Date: Jan. 26, 2017

(54) Communication Session Recording

(71) Applicant: Microsoft Technology Licensing, LLC, Redmond, WA (US)

(72) Inventors: Dan Mihai Benedict, Bellevue, WA (US); Gunter Leeb, Redmond, WA (US); Pascal Francis Menezes, Bellevue, WA (US)

(21) Appl. No.: 14/806,138

(22) Filed: Jul. 22, 2015

(51) Int. Cl. H04L 29/08; H04L 29/12; H04L 29/06

(52) U.S. Cl. CPC H04L 67/148; H04L 65/4007; H04L 61/25

(57) ABSTRACT

Techniques for communication session recording are described. According to various embodiments, communication policies are evaluated to ascertain whether a communication session is permitted and whether the communication session is to be recorded. According to various embodiments, a communication session is recorded by routing the communication session to a recording service.

### BACKGROUND

Modern communication systems have an array of capabilities, including integration of various communication modalities with different services. For example, systems that enable users to share and collaborate in creating and modifying various types of documents and content may be integrated with multimodal communication systems providing different kinds of communication and collaboration capabilities. Such integrated systems are sometimes referred to as Unified Communication (UC) systems.

While UC systems provide for increased flexibility in communications, they also present a number of implementation challenges. For instance, recording of UC data flows between different parties can be difficult since UC data flows are typically routed over different networks that are unaware of attributes of the individual flows.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for communication session recording are described. According to various embodiments, communication policies are evaluated to ascertain whether a communication session is permitted and whether the communication session is to be recorded. According to various embodiments, a communication session is recorded by routing the communication session to a recording service.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates an example implementation scenario for initiating recording of a communication session in accordance with one or more embodiments.

FIG. 3 depicts example policies in accordance with one or more embodiments.

FIG. 4 is a flow diagram that describes steps in a method for enabling recording of a communication session in accordance with one or more embodiments.

FIG. 5 is a flow diagram that describes steps in a method for updating communication policies in accordance with one or more embodiments.

FIG. 6 is a flow diagram that describes steps in a method for causing communication policies to be evaluated based on a request to initiate a communication session in accordance with one or more embodiments.

FIG. 7 is a flow diagram that describes steps in a method for causing a media flow of a communication session to be directed to a recording service in accordance with one or more embodiments.

FIG. 8 illustrates an example system and computing device as described with reference to FIG. 1, which are configured to implement embodiments of techniques described herein.

### DETAILED DESCRIPTION

### Overview

Techniques for communication session recording are described. A communication session, for instance, represents an exchange of communication media between different nodes in a network. Examples of a communication session include a Voice over Internet Protocol (VoIP) call, a video call, text messaging, a file transfer, and/or combinations thereof. In at least some embodiments, a communication session represents a Unified Communication (UC) session.

According to various implementations, a first user requests to initiate a communication session with a second user. For instance, the first user interacts with a communication service to request the communication session. In at least some implementations, the user interacts with the communication service via an over-the-top (“OTT”) application on a client device, such as a VoIP application, a UC application, and so forth. Attributes of the request are then compared to a set of communication policies to ascertain whether the communication session is permitted. For instance, the communication policies specify that communication sessions between particular entities are permitted, and/or that communication sessions between particular entities are not permitted.

Assuming that the communication session between the first user and the second user is permitted, attributes of the request are compared to the set of communication policies to ascertain whether the communication session is to be recorded. For instance, the communication policies specify that some communication sessions are to be recorded, and others are not to be recorded. In at least some implementations, the communication policies are entity-specific such that a communication session involving a particular entity and/or set of entities is to be recorded, and a communication session involving a different entity and/or set of entities is not to be recorded.

Further assuming that the communication session between the first user and the second user is to be recorded, a process is initiated to cause the communication session to be recorded. For instance, a recording service is invoked to record media flows of the communication session. In at least some implementations, the recording service is implemented by a third-party that is distinct from the communication service that initiates and manages the communication session. The recording service, for instance, is implemented as a standalone service separate from the communication service. Thus, the communication service can notify the recording service that the communication session is to be recorded to cause the recording service to record the communication session.

In at least some implementations, the communication policies referenced above are generated by the recording service, and communication policy evaluation and enforcement is performed by the communication service. For instance, the recording service propagates communication policies to the communication service, and the communication service evaluates individual communication sessions based on the communication policies to determine whether the communication sessions are permitted and/or are to be recorded.

Continuing with the example scenario, devices involved in the communication session are provided with addresses to be used for routing media flows of the communication session. For instance, the communication service communicates addresses for the recording service to end-user devices to cause the end-user devices to route the media flows to the recording service. Further, the communication service instructs the recording service to route media flows received as part of the communication session to the end-user devices. For instance, instead of being routed directly between the end-user devices, the communication session is rerouted to the recording service. Thus, the recording service records the communication session, and routes the communication session among participating end-user devices.

Accordingly, techniques for communication session recording described herein provide simple and transparent ways for recording communication sessions, such as by third-party entities not involved in initiating communication sessions. Further, information to be used for routing and recording communication sessions can be propagated among entities involved in recording the communication session and independent of the actual media flows of the communication session.

In the following discussion, an example environment is first described that is operable to employ techniques described herein. Next, a section entitled “Propagating Attributes of Communication Sessions” discusses some example ways for notifying different communication components of attributes of communication sessions. Following this, a section entitled “Example Implementation Scenario” describes an example implementation scenario in accordance with one or more embodiments. Next, a section entitled “Example Procedures” describes some example procedures in accordance with one or more embodiments. Finally, a section entitled “Example System and Device” describes an example system and device that are operable to employ techniques discussed herein in accordance with one or more embodiments.

Having presented an overview of example implementations in accordance with one or more embodiments, consider now an example environment in which example implementations may by employed.

Example Environment

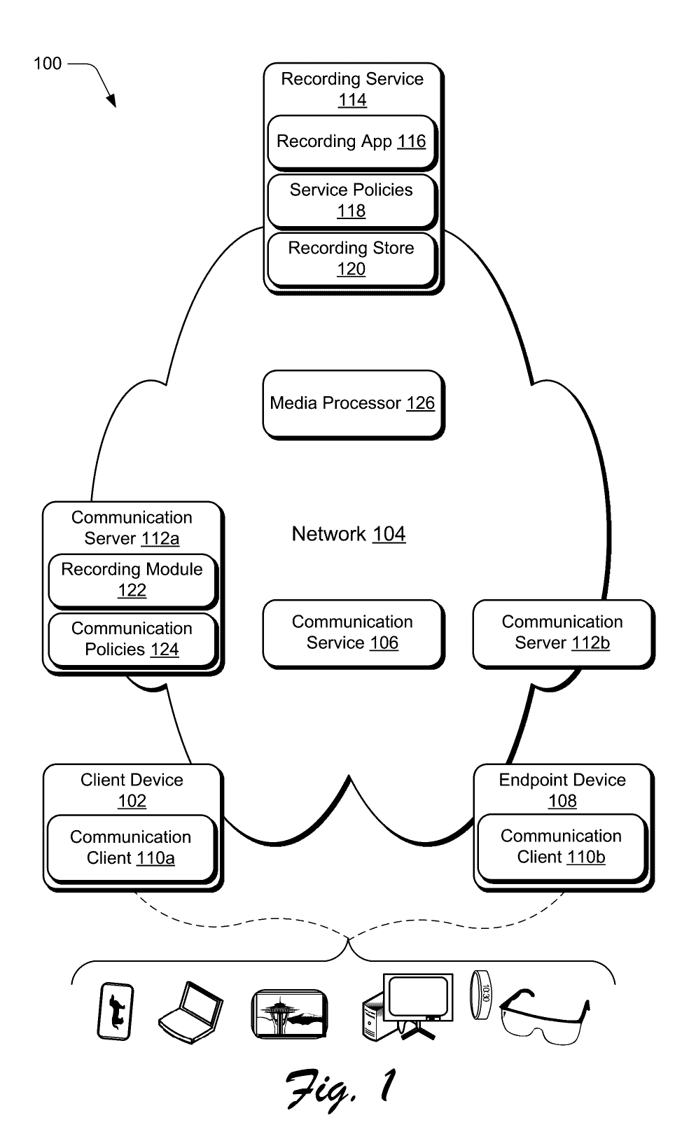

FIG. 1 is an illustration of an environment 100 in an example implementation that is operable to employ techniques for communication session recording described herein. Generally, the environment 100 includes various devices, services, and networks that enable communication via a variety of different modalities. For instance, the environment 100 includes a client device 102 connected to a network 104. The client device 102 may be configured in a variety of ways, such as a traditional computer (e.g., a desktop personal computer, laptop computer, and so on), a mobile station, an entertainment appliance, a smartphone, a netbook, a game console, a handheld device (e.g., a tablet), and so forth.

The network 104 is representative of one or more wired and/or wireless networks that provide the client device 102 with connectivity to various other networks, services, and/or entities. The network 104 may provide the client device 102 with connectivity via a variety of different connectivity technologies, such as broadband cable, digital subscriber line (DSL), wireless data connectivity (e.g., WiFi™), T-carrier (e.g., T1), Ethernet, cellular data connectivity, and so forth.

Connected to and/or implemented as part of the network 104 is a communication service 106, which is representative of a service to perform various tasks for management of communication between the client device 102 and an endpoint device 108. Generally, the endpoint device 108 is representative of any device with which the client device 102 may exchange data, such as an end-user device connected to the network 104. The communication service 106, for instance, can manage initiation, moderation, and termination of communication sessions. Examples of the communication service 106 include a VoIP service, an online conferencing service, a UC service, and so forth.

In at least some implementations, the client device 102 is configured to interface with the communication service 106 via a communication client 110a to enable communication between the client device 102 and the endpoint device 108. The communication client 110a is representative of functionality (e.g., an application and/or service) to enable different forms of communication via the client device 102. Examples of the communication client 110a include a voice communication client (e.g., a VoIP client), a video communication client, a messaging application, a content sharing application, and combinations thereof. The communication client 110a, for instance, enables different communication modalities to be combined to provide diverse communication scenarios.

According to one or more implementations, the communication client 110a represents an application that is installed on the client device 102. Additionally or alternatively, the communication client 110a can be implemented as a remote application, such as accessed via a web browser, a web application, and so forth.

The endpoint device 108 includes a communication client 110b, which represents an instance of the communication client 110a that can be leveraged by the endpoint device 108 to communicate with other devices. For instance, a communication session between the client device 102 and the endpoint device 108 represents an exchange of communication media between the communication client 110a and the communication client 110b.

The communication service 106 includes various infrastructure components that enable management of media flows across the network 104. For instance, the communication service 106 includes a communication server 112a and a communication server 112b. The communication server 112a, for instance, represents a front-end server that serves as a connection point between the client device 102 and the communication service 106. Similarly, in at least some implementations the communication server 112b represents a front-end server that that serves as a connection point between the client device 102 and the communication service 106. As further detailed below, the communication servers 112a, 112b can be leveraged to enable media flows of communication sessions to be routed and rerouted across the network 104.

The environment 100 further includes a recording service 114, which is representative of functionality for recording media flows across the network 104, such as communication sessions between the client device 102 and the endpoint device 108. In at least some implementations, the recording service 114 represents an entity that is implemented and managed independently of the communication service 106. For instance, the recording service 114 represents an entity that partners with the communication service 106 to record communication sessions that are initiated and managed by the communication service 106. Alternatively, the recording service 114 may be implemented and/or managed by the communication service 114.

The recording service 114 includes a recording application (“app”) 116, service policies 118, and a recording store 120. According to various implementations, the recording app 116 represents functionality for managing processes for recording of media flows. The service policies 118 represent policies generated by the recording service 114 and that specify various rules and parameters for media flows. For instance, the service policies 118 identify entities (e.g., users) that are permitted and/or not permitted to engage in communication sessions with one another. Further, the service policies 118 identify entities for which communication sessions are to be recorded. These policy types are presented for purpose of example only, and the service policies 118 may include a variety of other policies not specifically discussed herein.

The recording store 120 is representative of functionality for storing recordings of media flows, and for making the recordings accessible to different entities. For instance, media flows can be stored in persistent storage at the recording store 120, and published for access by authorized entities.

According to various implementations, recording of media flows is initiated by interaction between a recording module 122 of the communication server 112a and the recording service 114. For instance, and as detailed below, the recording module 122 can signal the recording app 116 to initiate recording of a media flow. The recording module 122 may be implemented in various ways, such as script that is executable to perform various tasks pertaining to recording of media flows.

The communication server 112a further maintains communication policies 124. Generally, the communication policies 124 are representative of rules and parameters to be applied to media flows. For instance, the communication policies 124 specify whether media flows are permitted to be initiated between particular entities. Further, the communication policies 124 specify whether media flows between particular entities are to be recorded. These policy types are presented for purpose of example only, and the communication policies 124 may include a variety of other policies not specifically discussed herein.

According to various implementations, the communication policies 124 are propagated to the communication server 112a from the recording service 114. For instance, the service policies 118 can be pushed from the recording service 114 to the communication server 112a, and/or pulled from the recording service 114 to the communication server 112a, and saved as the communication policies 124. Alternatively or additionally, instances of the communication policies 124 can be generated by other entities, such as the communication service 106. While the recording module 122 and the communication policies 124 are discussed as being implemented at the communication server 112a, it is to be appreciated that these functionalities can be implemented at a variety of other entities and/or locations.

The environment 100 further includes a media processor 126, which is representative of functionality for receiving, processing, and recording media flows. According to various implementations, a media flow of a communication session that is to be recorded is routed (e.g., rerouted) to the media processor 126. The media processor 126 processes the media flow and stores the media flow as an entry in the recording store 120. The media processor 126 further routes the media flow between entities involved in the communication session, e.g., the client device 102 and the endpoint device 108.

While the environment 100 is discussed with reference to a particular instance of the client device 102 and the endpoint device 108, it is to be appreciated that techniques for communication session recording described herein can be employed to route and record communication data for many different devices and networks in accordance with the claimed embodiments.

Having described an example environment in which the techniques described herein may operate, consider now a discussion of example ways of propagating various attributes of communication sessions in communication systems in accordance with one or more embodiments.

Propagating Attributes of Communication Sessions

According to various embodiments, techniques discussed herein can be employed to dynamically enlighten various network components with information about communication sessions. For instance, notification events can be generated that include various attributes of communication sessions. The notification events can be propagated to different entities further to techniques for communication session recording discussed herein.

In at least some embodiments, notification events can be configured using a communication application programming interface (API) that can be leveraged to configure and communicate session information to various network components involved in routing and/or recording a communication session. For example, the communication API can identify dialogue events and session events for which attributes of a communication session can be identified. Consider, for instance, the following events and attributes that may be conveyed via a notification event generated by the communication API:

Dialogue Events—These events apply to various portions of a communication session, such as the start, update, and end of a communication session. A dialogue event can include one or more of the following example attributes.

(1) Timestamp: This attribute can be leveraged to specify timestamps for a start of a communication session, updates that occur during a communication session, and an end (e.g., termination) of a communication session.

(2) Source IP Address: This attribute can be leveraged to specify an Internet Protocol (“IP”) address for a device that is a source of media during a communication session, e.g., a device that initiates a communication session.

(3) Destination IP Address: This attribute can be leveraged to specify an IP address for a device that is to receive media as part of a communication session.

(4) Transport Type: This attribute can be leveraged to specify a transport type or combination of transport types for a communication session. Examples of transport types include Transmission Control Protocol (TCP), User Datagram Protocol (UDP), and so forth.

(5) Source Port: this attribute can be leveraged to specify an identifier for a port at a source device, e.g., a source device identified by the Source IP Address referenced above.

(6) Destination Port: This attribute can be leveraged to specify an identifier for a port at a destination device, e.g., a destination device identified by the Destination IP Address referenced above.

(7) Redirect Address: This attribute can be leveraged to specify an address and/or addresses to which a media flow is to be redirected. The redirect address can be specified in various ways, such as an IP address, a port number, and so forth. In at least some implementations, the redirect address attribute specifies an address of an entity that is involved in recording a media flow, such as the media processor 126.

(8) Media Type: This attribute can be leveraged to specify a media type and/or types that are to be transmitted and/or are being transmitted as part of a communication session. As discussed elsewhere herein, the communication session can involve multiple different types of media. Thus, the Media Type attribute can be employed to identify media types in a communication session, such as for applying the policies discussed herein.

(9) Bandwidth Estimation: This attribute can be leveraged to specify an estimated bandwidth that is to be allocated for a communication session. The estimated bandwidth, for instance, can be based on various factors, such as a privilege level associated with a user, type and/or types of media included in a communication session, and so forth.

(10) To: This attribute can be leveraged to identify a user to which media in a communication session is to be transmitted.

(11) From: This attribute can be leveraged to identify a user from which media in a communication session is transmitted.

(12) Error Code: This attribute can be leveraged to specify various error codes for errors that may occur as part of a communication session. For example, errors can include errors that occur during initiation the communication session, errors that occurred during a communication session, errors that occur when a communication session is terminated, and so forth.

Session Problem Events—These events can be generated and applied when a communication session experiences errors, performance degradation, and so forth. A session problem event may include one or more of the attributes discussed above with reference to Dialogue Events, and may also include one or more of the following attributes. In at least some implementations, a problem encountered during a communication session can cause the communication session to be rerouted within a network and/or to a different network.

(1) Mean Opinion Score (MOS) Degradation: This attribute can be leveraged to specify a MOS for a communication session. The attribute, for instance, can be used to indicate that an overall quality of a communication session has decreased.

(2) Jitter Inter-Arrival Time: This attribute can be leveraged to specify jitter values for a communication session. The attribute, for instance, can be used to indicate that a jitter value or values have increased, e.g., have exceeded a specified jitter value threshold.

(3) Packet Loss Rate: This attribute can be leveraged to specify a packet loss rate for a communication session. The attribute, for instance, can be used to indicate that a packet loss rate has increased, e.g., has exceeded a specified packet loss rate value threshold.

(4) Round Trip Delay (RTD): This attribute can be leveraged to specify RTD values for packets in communication sessions. The attribute, for instance, can be used to indicate that RTD values for packets have increased, e.g., have exceeded a specified RTD value threshold.

(5) Concealment Ratio: This attribute can be leveraged to specify a cumulative ratio of concealment time over speech time observed after starting a communication session. The attribute, for instance, can be used to specify that a concealment ratio has increased, e.g., has exceeded a specified concealment ratio value threshold.

Thus, various notifications discussed herein can include one or more of the attributes discussed above and can be used to propagate the attributes to various entities.

Having described an example ways of propagating attributes of communication sessions, consider now an example implementation scenario for communication session recording in accordance with one or more embodiments.

Example Implementation Scenario

The following section describes an example implementation scenario for communication session recording in accordance with one or more embodiments. The implementation scenario may be implemented in the environment 100 discussed above, and/or any other suitable environment.

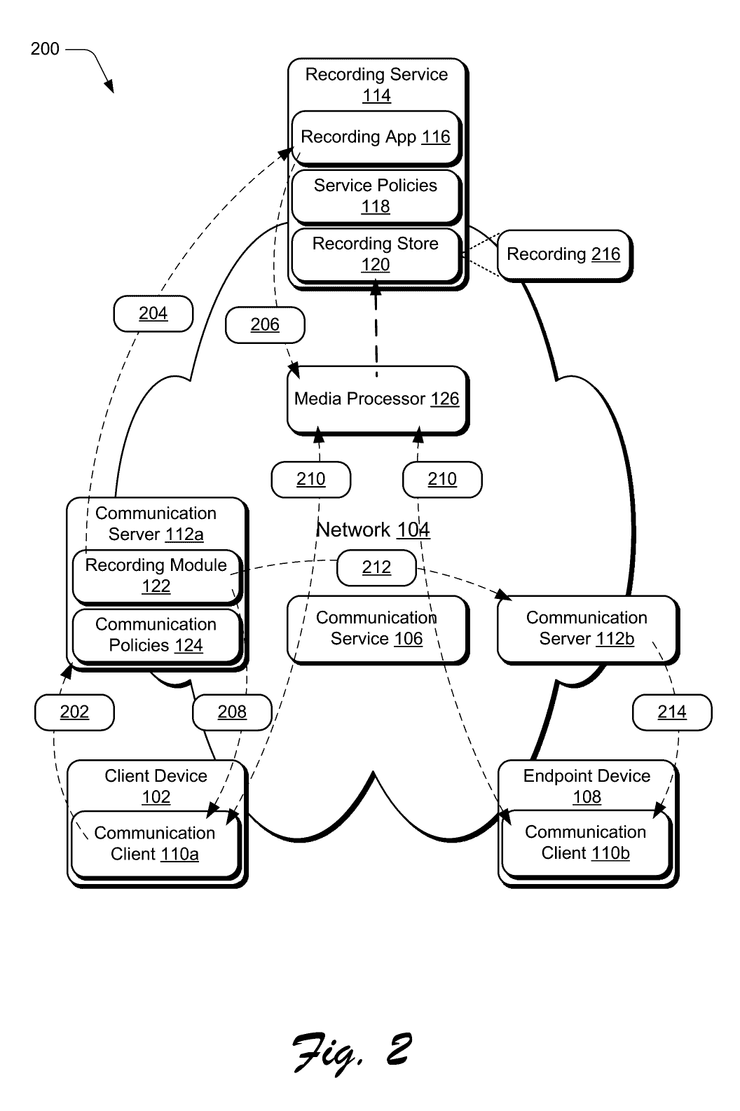

FIG. 2 illustrates an example implementation scenario 200 for initiating recording of a communication session in accordance with one or more implementations. The scenario 200 includes various entities and components introduced above with reference to the environment 100.

In the scenario 200, a user of the client device 102 performs an action to initiate a communication session with the endpoint device 108. For instance, the user interacts with the communication client 110a to initiate a communication session, such as by dialing a telephone number, selecting a contact, selecting a hyperlink, and so forth. In response, the communication client 110a communicates an initiation notification 202 to the communication server 112a. In at least some implementations, the notification 202 includes the communication API discussed above. Attributes of the communication API, for instance, are populated at least in part with values that identify various attributes of the communication session.

In response to detecting the notification 202, the recording module 122 reads attributes of the notification 202 (e.g., from the communication API) and compares the attributes to the communication policies 124. For instance, the recording module 122 ascertains whether the communication policies 124 indicate that a user of the client device 102 is permitted to engage in a communication session with a user of the endpoint device 108. Assuming that the communication session is permitted, the recording module 122 then ascertains whether the communication policies 124 indicate that the communication session is to be recorded. For purposes of the scenario 200, assume that the communication policies 124 indicate that a communication session between the client device 102 and the endpoint device 108 is permitted, and that the communication session is to be recorded.

Accordingly, the recording module 122 configures a session notification 204 and communicates the notification 204 to the recording app 116 to initiate recording of the communication session. The recording module 122, for instance, configures the notification 204 using the communication API. The notification 204, for example, identifies the client device 102 and the endpoint device 108. Further, the notification 204 may include an identifier that can be used to tag media of the communication session and/or a recording of the communication session. In at least some implementations, configuring the notification 204 includes indicating an address redirect to be used to redirect the communication session to the media processor 126, e.g., instead of being sent directly from the client device 102 to the endpoint device 108. The address redirect, for instance, specifies one or more port addresses for the media processor 126. Further, the notification 204 includes addresses for the client device 102 and the endpoint device 108 such that media flows received for the communication session at the media processor 126 are routed to the respective devices.

In response to receiving the notification 204, the recording app 116 communicates an invoke notification 206 to the media processor 126. The invoke notification 206, for instance, is populated with the communication API, which is configured with different attributes of the communication session. Generally, the invoke notification 206 instructs the media processor 126 to record the communication session in the recording store 120, and to route a media flow of the communication session between the client device 102 and the endpoint device 108. For example, the notification 206 includes addresses provided by the recording module 122 from the notification 204.

Continuing with the scenario 200, the recording module 122 communicates an answer notification 208 to the communication client 110a instructing the communication client 110a to send media for the communication session to the media processor 126. The recording module 122, for instance, configures the notification 208 to include an address redirect to be used to redirect the communication session to the media processor 126, e.g., instead of being sent directly from the client device 102 to the endpoint device 108. For example, the address redirect specifies one or more addresses for the media processor 126. Accordingly, the communication client 110a initiates a media flow 210 to the media processor 126 that represents media data of a communication session. The media flow 210 may include various types of media, such as voice, video, messaging, content data, and so forth. In at least some implementations, initiation and management of the media flow 210 are performed by the communication service 106.

To enable the endpoint device 108 to route media data of the communication session to the media processor 126 for recording, the recording module 122 communicates a routing notification 212 to the communication server 112b. The notification 212, for instance, is configured using the communication API. The notification 212 includes a redirect address (e.g., an IP address and/or port number) for the media processor 126 such that media data sent from the endpoint device 108 is routed to the media processor 126. Accordingly, the communication server 112b communicates a call notification 214 to the communication client 110b that includes information from the notification 212, including the address for the media processor 126 and other attributes of the communication session, such as identifier for the client device 102 and a user of the client device 102. Media data sent from the endpoint device 108 as part of the media flow 210 is then forwarded to the media processor 126. Thus, the media flow 210 represents a real-time exchange of media data between the client device 102 and the endpoint device 108 via the media processor 126 as part of a communication session.

Further to the scenario 200, the media processor 126 records the media flow 210 as a recording 216 in the recording store 120. In at least some implementations, the media processor 126 encrypts the media flow 210 before it is recorded. Thus, the recording 216 can be encrypted to protect its media content from being exposed in the clear to an unauthorized entity. An authorized entity may access and decrypt the recording 216 to view and/or playback its content. The recording 216, for instance, may be played back to present the content recorded as part of the media flow 210, such as audio content, video content, messaging, and so forth.

Thus, the scenario 200 illustrates that techniques for communication session recording discussed herein can be employed to redirect a media flow of a communication session to a recording service to cause the media flow to be recorded. In at least some implementations, the media flow is recorded transparently to participants in the communication session. For instance, the participants may not be notified that the communication session is being recorded. Alternatively, a notification may be presented to participants indicating that the communication session is being recorded.

In at least some implementations, the routing information for the media flow 210 is propagated to different entities without handling the media flow 210 itself. For instance, the recording module 122 ascertains attributes (e.g., signaling data, metadata, and so forth) of the media flow 210, and propagates the attributes for the media flow 210 to different entities without handling media data of the media flow 210.

According to various implementations, the scenario 200 occurs in real-time and in response to initiation of a communication session. For instance, the media flow 210 is routed to the media processor 210 and recorded in the recording store 120 in real-time while the communication session is in progress. Thus, techniques described herein enable real-time path redirection and recording for communication sessions. Further, while a single path rerouting to the media processor 126 is described, it is to be appreciated that techniques for communication session recording described herein can be dynamically applied to cause a communication session to be rerouted multiple times, such as based on changes in performance of the media processor 126. For instance, if the media processor 126 malfunctions and/or a media path to the media processor 126 experiences quality degradation, the media flow 210 can be rerouted to a different media processor for recording.

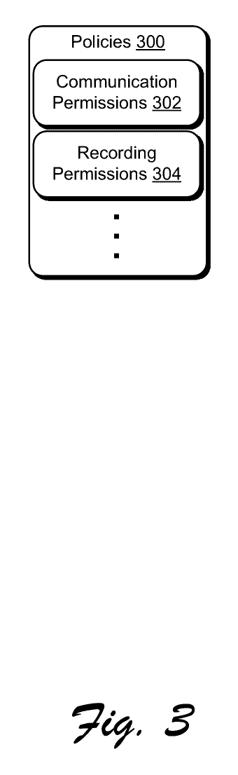

FIG. 3 depicts example policies 300 in accordance with one or more implementations. The policies 300, for example, represent instances of the communication policies 124 and/or the service policies 118.

The policies 300 include communication permissions 302 and recording permissions 304. According to various implementations, the communication permissions 302 specify entities that are permitted to initiate communication sessions with one another, and/or entities that are not permitted to initiate communication sessions with one another. The communication permissions 302 may be user-specific. For instance, the communication permissions 302 may include identifiers for individual users and/or combinations of users that are or are not permitted to initiate communication sessions with one another. Alternatively or additionally, the communication permissions 302 may be defined with respect to particular organization entities, such as enterprise organizations, government organizations, regulatory organizations, and so forth.

In yet another example implementation, the communication permissions 302 may be role-specific. For instance, the communication permissions 302 may specify that authenticated users of the communication clients 110a, 110b are permitted to initiate communication sessions with one another, whereas guest users are not. Other roles may be associated with the communication permissions 302, such as network-based roles (e.g., administrator, user, and so forth), organizational roles (e.g., staff, associate, manager, director, and so forth), and so on. In at least some implementations, the attributes described above may be combined to generate a variety of different communication permissions 302. Thus, the communication permissions 302 may be configured in a variety of ways to identify entities that are permitted to initiate communication sessions with one another, and/or those that are not.

The recording permissions 304 specify entities for which communication sessions are to be recorded, and/or entities for which communication sessions are not to be recorded. The recording permissions 304 may be user-specific. For instance, the recording permissions 304 may include identifiers for individual users and/or combinations of users for which communication sessions are to be recorded. Alternatively or additionally, the recording permissions 304 may be defined with respect to particular organization entities, such as enterprise organizations, government organizations, and so forth for which communication sessions are to be recorded or not recorded.

In yet another example implementation, the recording permissions 304 may be role-specific. For instance, the recording permissions 304 may specify that communication sessions between authenticated users of the communication clients 110a, 110b are to be recorded, whereas communication sessions between guest users are not. Other roles may be associated with the recording permissions 304, such as network-based roles (e.g., administrator, user, and so forth), organizational roles (e.g., staff, associate, manager, director, and so forth), and so on. In at least some implementations, the attributes described above may be combined to generate a variety of different recording permissions 304. Thus, the recording permissions 304 may be configured in a variety of ways to identify entities for which communication sessions are to be recorded, and/or those that are not.

These particular policies 300 are presented for purpose of example only, and it is to be appreciated that a wide variety of other policies may be configured and enforced in accordance with the implementations discussed herein.

Having discussed some example implementation scenarios, consider now a discussion of some example procedures in accordance with one or more embodiments.

Example Procedures

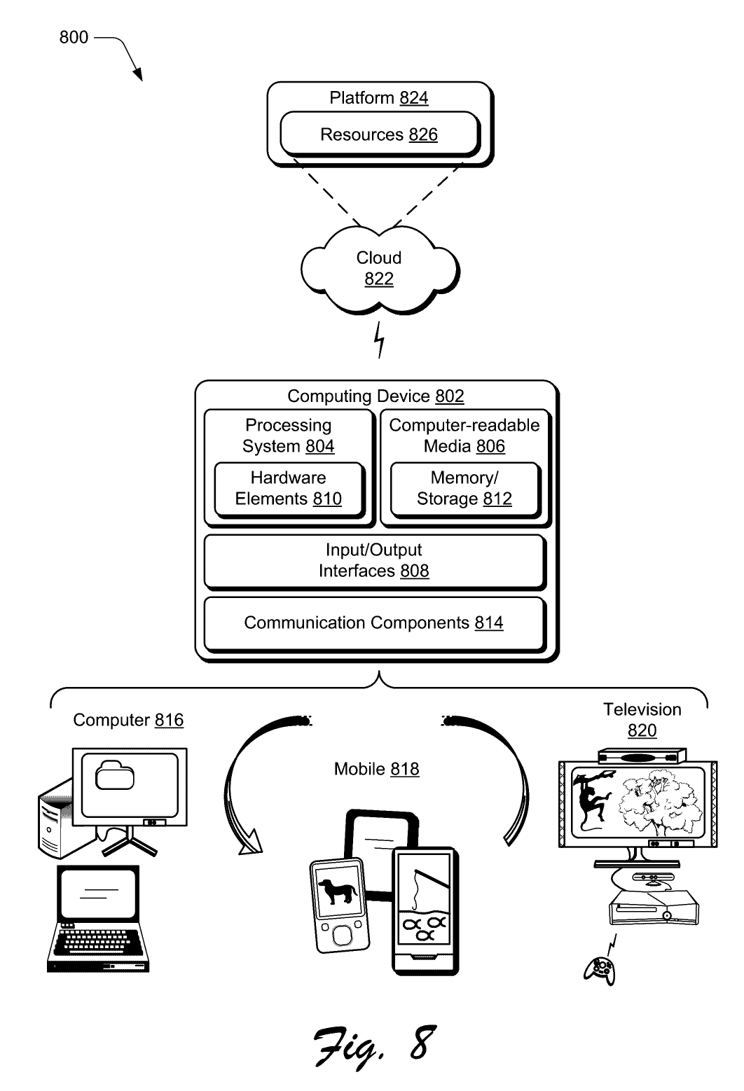

The following discussion describes some example procedures for communication session recording in accordance with one or more embodiments. The example procedures may be employed in the environment 100 of FIG. 1, the system 800 of FIG. 8, and/or any other suitable environment. In at least some implementations, the steps described for the various procedures can be implemented automatically and independent of user interaction. The procedures, for instance, represent example ways of performing various aspects of the implementation scenario described above.

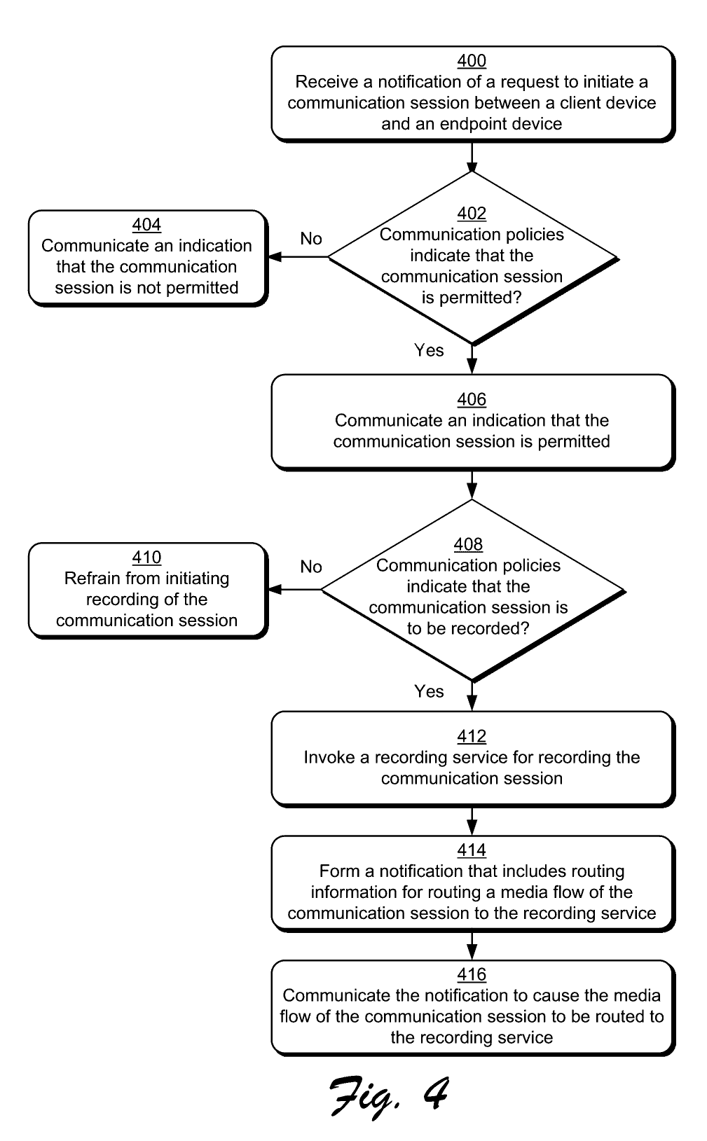

FIG. 4 is a flow diagram that describes steps in a method in accordance with one or more implementations. The method describes an example procedure for enabling recording of a communication session in accordance with one or more implementations.

Step 400 receives a notification of a request to initiate a communication session between a client device and an endpoint device. The recording module 122, for instance, receives an indication that the communication client 110a requests to initiate a communication session with the communication client 110b. The notification may be implemented in various ways. For instance, the notification may be implemented using the communication API discussed above, and thus may include various attributes and values discussed with reference to the communication API. In at least some implementations, the notification represents signaling information (e.g., metadata) that identifies attributes of the requested communication session, such as entities to be involved (e.g., participants), media types, scheduling information (e.g., date and time), and so forth.

Step 402 ascertains whether communication policies indicate that the communication session is permitted. The recording module 122, for instance, compares one or more attributes received with the request to the communication policies 124. Alternatively or additionally, the recording module 122 communicates the one or more attributes of the request to the recording service 114, and the recording service 114 compares the attributes to the service policies 118. The communication permissions 302, for example, are evaluated to ascertain whether entities (e.g., users, organizations, enterprise entities, and so forth) identified in the attributes of the request are permitted to initiate a communication session with one another.

If the communication policies indicate that the communication session is not permitted (“No”), step 404 communicates an indication that the communication session is not permitted. For instance, the one or more policies specify that entities identified in the attributes of the request are not permitted to initiate a communication session with one another. In at least some implementations, the recording module 122 notifies the communication client 110a and/or other entity that the communication session is not permitted. Thus, the communication client 110a denies the request to initiate the communication session.

If the communication policies indicate that the communication session is permitted (“Yes”), step 406 communicates an indication that the communication session is permitted. For instance, the one or more policies specify that entities identified in the attributes of the request are permitted to initiate a communication session with one another. In at least some implementations, the recording module 122 notifies the communication client 110a and/or other entity that the communication session is permitted. Thus, the communication client 110a initiates the communication session.

Step 408 ascertains whether the communication policies indicate that the communication session is to be recorded. The recording permissions 304, for example, are evaluated to ascertain whether a communication session between entities (e.g., users, organizations, enterprise entities, and so forth) identified in the attributes of the request are to be recorded.

If the communication policies indicate that the communication session is not to be recorded (“No”), step 410 refrains from initiating recording of the communication session. For instance, the one or more policies specify that a communication session between entities identified in the attributes of the request is not to be recorded. Thus, the recording module 122 does not invoke the recording app 116 to initiate recording of the communication session.

If the communication policies indicate that the communication session is to be recorded (“Yes”), step 412 invokes a recording service for recording the communication session. For instance, the one or more policies specify that a communication session between entities identified in the attributes of the request is to be recorded. Thus, the recording module 122 communicates a notification to the recording app 116 instructing the recording app 116 to record the communication session. According to various implementations, the notification includes information for identifying a media flow of the communication session, such as user and/or device identifiers (“IDs”) for participants in the communication session, a session ID generated for the communication session, and so forth.

Step 414 forms a notification that includes routing information for routing a media flow of the communication session to the recording service. For instance, the recording module 122 generates a notification that includes routing information (e.g., an address or addresses) for routing a media flow of the communication session to the media processor 126.

Step 416 communicates the notification to cause the media flow of the communication session to be routed to the recording service. The recording module 122, for example, communicates the notification to the client device 102 and the endpoint device 108. The client device 102 and the endpoint device 108 utilize the routing information to route the media flow of the communication session to the recording service such that the media flow is recorded by the recording service. For instance, the client device 102 and the endpoint device 108 address the media flow to the media processor 126, which routes the media flow between the client device 102 and the endpoint device 108, and records the media flow to the recording store 120.

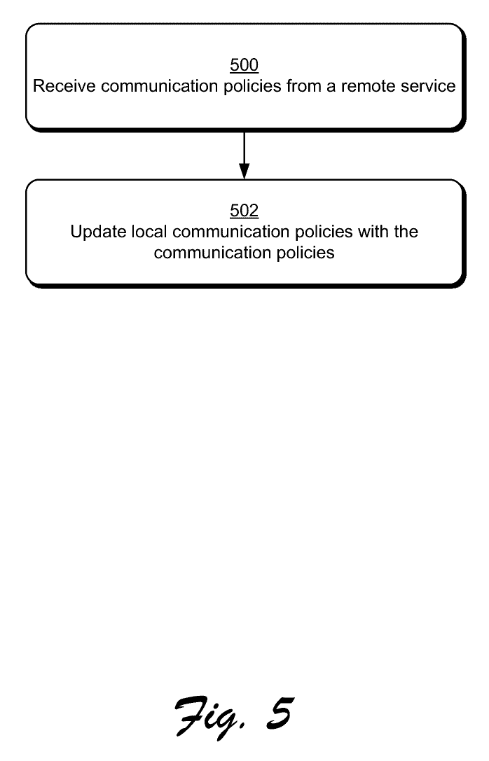

FIG. 5 is a flow diagram that describes steps in a method in accordance with one or more implementations. The method describes an example procedure for updating communication policies in accordance with one or more implementations.

Step 500 receives communication policies from a remote service. The recording module 122, for instance, receives communication policies from the recording service 114. For example, the recording service 114 pushes communication policies to the recording module 122, such as independent of a query from the recording module 122 for communication policies. Alternatively or additionally, the recording module 122 communicates a query to the recording service 114 for communication policies, and the recording service 114 returns communication policies to the recording module 122 in response to the query.

Step 502 updates local communication policies with the communication policies. The recording module 122, for instance, updates the communication policies 124 with communication policies received from the recording service 114. Generally, the received communication policies may include new communication policies, replacement communication policies, and/or updates to existing communication policies.

According to various implementations, this procedure may be performed periodically (e.g., daily, weekly, and so forth) to update communication policies. Alternatively or additionally, the procedure may be performed dynamically, such as in response to an indication of a change in an existing communication policy and/or an indication that a new communication policy is available.

As an additional or alternative implementation to the procedure described above, communication policies may be locally configured. For instance, an administrator or other entity may interact with the communication server 112a to configure and/or update the communication policies 124.

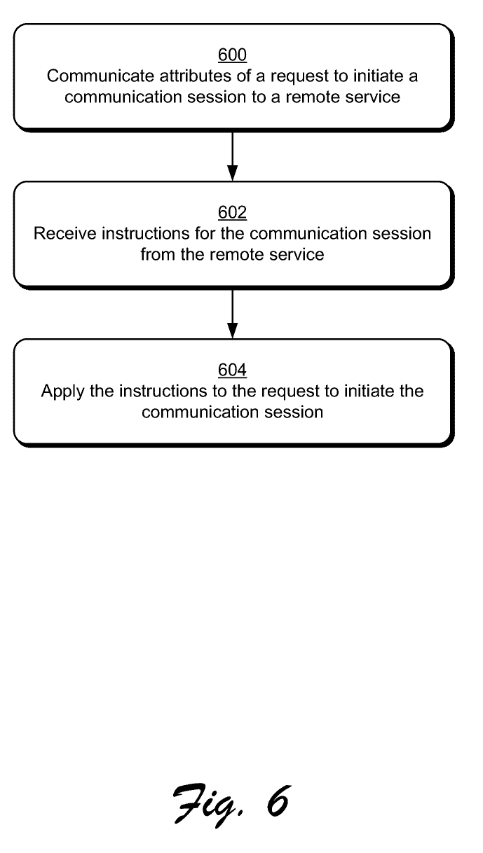

FIG. 6 is a flow diagram that describes steps in a method in accordance with one or more implementations. The method describes an example procedure for causing communication policies to be evaluated based on a request to initiate a communication session in accordance with one or more implementations.

Step 600 communicates attributes of a request to initiate a communication session to a remote service. The recording module 122, for instance, receives an indication of a request to initiate a communication session, such as from the client device 102. The recording module 122 communicates attributes of the request to the recording service 114, such as using the communication API detailed above. For example, the recording module 122 communicates IDs for entities that are to participate in the communication session to the recording service 114.

Step 602 receives instructions for the communication session from the remote service. The recording service 114, for instance, compares the attributes to the service policies 118 to determine whether the communication session is permitted and/or whether the communication session is to be recorded. Based on this comparison, the recording service 114 generates instructions for the communication session and communicates the instructions to the recording module 122, e.g., via the communication service 106.

Step 604 applies the instructions to the request to initiate the communication session. The recording module 122, for instance, applies the instructions to allow or deny the request to initiate the communication session, and/or to cause the communication session to be recorded.

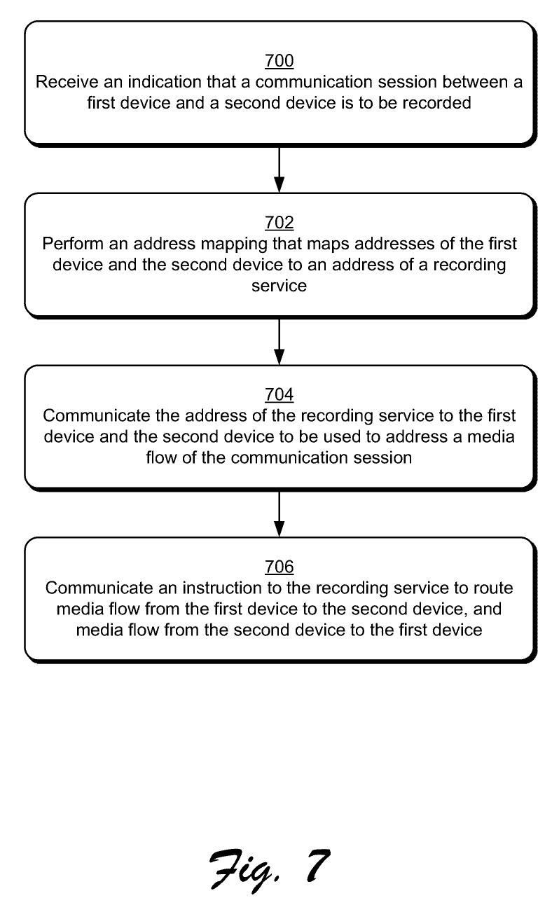

FIG. 7 is a flow diagram that describes steps in a method in accordance with one or more implementations. The method describes an example procedure for causing a media flow of a communication session to be directed to a recording service in accordance with one or more implementations.

Step 700 receives an indication that a communication session between a first device and a second device is to be recorded. The recording module 122, for instance, ascertains that a communication session between the client device 102 and the endpoint device 108 is to be recorded. For example, the recording module 122 compares attributes of the communication session to the communication policies 124 to ascertain that the communication session is to be recorded. Alternatively or additionally, the recording module 122 communicates attributes of the communication session to the recording service 114, and the recording service 114 returns an instruction indicating that the communication session is to be recorded.

Step 702 performs an address mapping that maps addresses of the first device and the second device to an address of a recording service. The recording module 122, for instance, maps an IP/port address of the client device 102 to a first IP/port address for the media processor 126, and maps an IP/port address of the endpoint device 108 to a second IP/port address for the media processor 126.

Step 704 communicates the address of the recording service to the first device and the second device to be used to address a media flow of the communication session. For example, the recording module 122 communicates the first IP/port address for the media processor 126 to the client device 102, and the second IP/port address for the media processor 126 to the endpoint device 108. Accordingly, the client device 102 addresses a media flow of the communication session using the first IP/port address such that the media flow is routed to the media processor 126. Further, the endpoint device 108 addresses a media flow of the communication session using the second IP/port address such that the media flow is routed to the media processor 126.

Step 706 communicates an instruction to the recording service to route media flow from the first device to the second device, and media flow from the second device to the first device. The recording module 122, for example, communicates a notification to the media processor 126 to route media flow received from the client device 102 to the endpoint device 108, and to route media flow received from the endpoint device 108 to the client device 102. Thus, the media processor not only records the media flow in the recording store 120, but routes the media flow between the client device 102 and the endpoint device 108.

In at least some implementations, the instruction is specified with reference to IP/port addresses at the media processor 126. For instance, the instruction specifies that media flow received at an IP/port address assigned to the client device 102 is to be forwarded to the endpoint device 108, and that media flow received at an IP/port address assigned to the endpoint device 108 is to be forwarded to the client device 102.

According to implementations discussed herein, the different notifications, instructions, and communications described above can be generated and communicated with the communication API introduced above. For instance, attributes of the communication API can be populated with values based on the various notifications, such as media attributes, user attributes, device attributes, and so forth. Further, attributes of the communication API can be populated and updated in real-time, such as in response to initiation of a communication session.

According to various implementations, the various aspects of the implementation scenario and procedures described above are performed without handling data of a communication session. For instance, the recording module 122 receives attributes of communication sessions and invokes routing and recording of communication sessions without receiving and handling media data of the communication sessions.

Thus, techniques for communication session recording discussed herein provide convenient and non-obtrusive ways for causing communication sessions to be recorded. Further, according to techniques discussed herein, a communication service that manages media flow among participants in a communication session (e.g., the communication service 106) need not maintain its own recording service, but may interface with an external third-party recording service (e.g., the recording service 114) to enable communication sessions managed by the communication service to be recorded.

Having discussed some example procedures, consider now a discussion of an example system and device in accordance with one or more embodiments.

Example System and Device

FIG. 8 illustrates an example system generally at 800 that includes an example computing device 802 that is representative of one or more computing systems and/or devices that may implement various techniques described herein. For example, the client device 102, the endpoint device 108, and/or the communication service 106 discussed above with reference to FIG. 1 can be embodied as the computing device 802. The computing device 802 may be, for example, a server of a service provider, a device associated with the client (e.g., a client device), an on-chip system, and/or any other suitable computing device or computing system.

The example computing device 802 as illustrated includes a processing system 804, one or more computer-readable media 806, and one or more Input/Output (I/O) Interfaces 808 that are communicatively coupled one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 806 is illustrated as including memory/storage 812. The memory/storage 812 represents memory/storage capacity associated with one or more computer-readable media. The memory/storage 812 may include volatile media (such as random access memory (RAM)) and/or nonvolatile media (such as read only memory (ROM), Flash memory, optical disks, magnetic disks, and so forth). The memory/storage 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 802 may be configured in a variety of ways as further described below to support user interaction.

The computing device 802 further includes communication components 814, which are representative of functionality to receive and transmit data for the computing device 802. For instance, the communication components 814 represent components for interfacing and communicating with a network, such as via any suitable wired and/or wireless protocol. According to various implementations, the communication components 814 receive data transmitted to the computing device 802 and route the data to one or more other components of the computing device 802. Further, the communication components 814 receive data from one or more internal components of the computing device 802, and cause the data to be communicated to various entities (e.g., devices) remote from the computing device 802.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 810 and computer-readable media 806 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of modules that are executable by the computing device 802 as software may be achieved at least partially in hardware, e.g., through use of computer-readable storage media and/or hardware elements 810 of the processing system. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 802 may assume a variety of different configurations, such as for computer 816, mobile 818, and television 820 uses. Each of these configurations includes devices that may have generally different constructs and capabilities, and thus the computing device 802 may be configured according to one or more of the different device classes. For instance, the computing device 802 may be implemented as the computer 816 class of a device that includes a personal computer, desktop computer, a multi-screen computer, laptop computer, netbook, and so on.

The computing device 802 may also be implemented as the mobile 818 class of device that includes mobile devices, such as a mobile phone, portable music player, portable gaming device, a tablet computer, a wearable device, a multi-screen computer, and so on. The computing device 802 may also be implemented as the television 820 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. For example, functionalities discussed with reference to the communication service 106 and/or the recording service 114 may be implemented all or in part through use of a distributed system, such as over a “cloud” 822 via a platform 824 as described below.

The cloud 822 includes and/or is representative of a platform 824 for resources 826. The platform 824 abstracts underlying functionality of hardware (e.g., servers) and software resources of the cloud 822. The resources 826 may include applications and/or data that can be utilized while computer processing is executed on servers that are remote from the computing device 802. Resources 826 can also include services provided over the Internet and/or through a subscriber network, such as a cellular or Wi-Fi network.

The platform 824 may abstract resources and functions to connect the computing device 802 with other computing devices. The platform 824 may also serve to abstract scaling of resources to provide a corresponding level of scale to encountered demand for the resources 826 that are implemented via the platform 824. Accordingly, in an interconnected device embodiment, implementation of functionality described herein may be distributed throughout the system 800. For example, the functionality may be implemented in part on the computing device 802 as well as via the platform 824 that abstracts the functionality of the cloud 822.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Implementations discussed herein include:

### Example 1

A system for recording a communication session, the system including: at least one processor; and one or more computer-readable storage media including instructions stored thereon that, responsive to execution by the at least one processor, cause the system perform operations including: receiving one or more attributes of a communication session that is initiated at client device for communicating with an endpoint device; applying the one or more attributes to one or more policies to determine that the communication session is to be recorded; forming a notification that includes routing information for routing a media flow of the communication session to a recording service; and communicating the notification to cause the client device and the endpoint device to route the media flow of the communication session to the recording service such that the media flow is recorded by the recording service.

### Example 2

A system as described in example 1, wherein said receiving includes receiving an application programming interface (API) that is populated with the one or more attributes.

### Example 3

A system as described in one or more of examples 1 or 2, wherein said applying includes applying the one or more attributes to the one or more policies to determine that the communication session is permitted.

### Example 4

A system as described in one or more of examples 1-3, wherein the operations further include receiving the one or more policies from the recording service.

### Example 5

A system as described in one or more of examples 1-4, wherein the operations further include mapping an address of the client device to an address of the recording service, and wherein the routing information includes the address of the recording service such that media flow of the communication session is routed from the client device using the address of the recording service.

### Example 6

A system as described in one or more of examples 1-5, wherein the operations further include mapping an address of the endpoint device to an address of the recording service, and wherein the routing information includes the address of the recording service such that media flow of the communication session is routed from the endpoint device using the address of the recording service.

### Example 7

A system as described in one or more of examples 1-6, wherein the operations further include: mapping an address of the client device to a first address of the recording service, and wherein the routing information includes the first address of the recording service such that media flow of the communication session is routed from the client device using the first address of the recording service; and mapping an address of the endpoint device to a second address of the recording service, and wherein the routing information includes the second address of the recording service such that media flow of the communication session is routed from the endpoint device using the second address of the recording service.

### Example 8

A system as described in one or more of examples 1-7, wherein the operations further include communicating a notification to the recording service to route a portion of the media flow received from the client device to the endpoint device, and to route a portion of the media flow received from the endpoint device to the client device.

### Example 9

A system as described in one or more of examples 1-8, wherein said communicating includes communicating the notification separately and independently from data of the media flow.

### Example 10

A computer-implemented method for recording a communication session, the method including: receiving a notification of a request to initiate a communication session between a client device and an endpoint device; applying one or more attributes of the request to one or more policies to determine that the communication session is permitted and that the communication session is to be recorded; forming a notification that includes routing information for routing a media flow of the communication session to a recording service; and communicating the notification to cause the client device and the endpoint device to route the media flow of the communication session to the recording service such that the media flow is recorded by the recording service.

### Example 11

A method as described in example 10, wherein said receiving includes receiving an application programming interface (API) that is populated with the one or more attributes, and wherein said forming includes forming the notification using at least a portion of the API.

### Example 12

A method as described in one or more of examples 10 or 11, further including receiving the one or more policies from the recording service in response to a query to the recording service for communication policies.

### Example 13

A method as described in one or more of examples 10-12, further including receiving the one or more policies from the recording service as part of a policy update from the recording service.

### Example 14

A method as described in one or more of examples 10-13, further including: mapping an address of the client device to a first address of the recording service, and wherein the routing information includes the first address of the recording service such that media flow of the communication session is routed from the client device using the first address of the recording service; and mapping an address of the endpoint device to a second address of the recording service, and wherein the routing information includes the second address of the recording service such that media flow of the communication session is routed from the endpoint device using the second address of the recording service.

### Example 15

A method as described in one or more of examples 10-14, wherein said communicating includes communicating the notification separately and independently from data of the media flow.

### Example 16

A system for recording a communication session, the system including: a recording module configured to: receive signaling information indicating a request to initiate a communication session between a client device and an endpoint device; receive one or more policies from a remote recording service; apply one or more attributes of the request to the one or more policies to determine that the communication session is permitted and that the communication session is to be recorded; and form a notification that includes routing information for routing a media flow of the communication session to the recording service; and a communication component configured to communicate the notification to cause the client device and the endpoint device to route the media flow of the communication session to the recording service such that the media flow is recordable by the recording service.

### Example 17

A system as described in example 16, wherein the recording module is configured to receive the signaling information separately and independently from media data included in the media flow.

### Example 18

A system as described in one or more of examples 16 or 17, wherein the recording module is further configured to invoke the recording service to initiate recording of the communication session.

### Example 19

A system as described in one or more of examples 16-18, wherein the one or more policies include a communication permission and a recording permission, and wherein the recording module is configured to compare one or more of the attributes to the communication permission to determine that the communication session is permitted, and to compare one or more of the attributes to the recording permission to determine that the communication session is to be recorded.

### Example 20

A system as described in one or more of examples 16-19, wherein the recording module is further configured to form a different notification that indicates that a portion of the media flow received from the client device is to be routed to the endpoint device, and that a portion of the media flow received from the endpoint device is to be routed to the client device, and wherein the communication component is further configured to communicate the different notification to the recording service to cause the media flow received at the recording service to be routed between the client device and the endpoint device.

### CONCLUSION

Techniques for communication session recording are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
at least one processor; and
one or more computer-readable storage media including instructions stored thereon that, responsive to execution by the at least one processor, cause the system perform operations including:
receiving one or more attributes of a communication session that is initiated at client device for communicating with an endpoint device;
applying the one or more attributes to one or more policies to determine that the communication session is to be recorded;
forming a notification that includes routing information for routing a media flow of the communication session to a recording service; and
communicating the notification to cause the client device and the endpoint device to route the media flow of the communication session to the recording service such that the media flow is recorded by the recording service.

2. A system as recited in claim 1, wherein said receiving comprises receiving an application programming interface (API) that is populated with the one or more attributes.

3. A system as recited in claim 1, wherein said applying comprises applying the one or more attributes to the one or more policies to determine that the communication session is permitted.

4. A system as recited in claim 1, wherein the operations further comprise receiving the one or more policies from the recording service.

5. A system as recited in claim 1, wherein the operations further comprise mapping an address of the client device to an address of the recording service, and wherein the routing information comprises the address of the recording service such that media flow of the communication session is routed from the client device using the address of the recording service.

6. A system as recited in claim 1, wherein the operations further comprise mapping an address of the endpoint device to an address of the recording service, and wherein the routing information comprises the address of the recording service such that media flow of the communication session is routed from the endpoint device using the address of the recording service.

7. A system as recited in claim 1, wherein the operations further comprise:
mapping an address of the client device to a first address of the recording service, and wherein the routing information comprises the first address of the recording service such that media flow of the communication session is routed from the client device using the first address of the recording service; and
mapping an address of the endpoint device to a second address of the recording service, and wherein the routing information comprises the second address of the recording service such that media flow of the communication session is routed from the endpoint device using the second address of the recording service.

8. A system as recited in claim 1, wherein the operations further comprise communicating a notification to the recording service to route a portion of the media flow received from the client device to the endpoint device, and to route a portion of the media flow received from the endpoint device to the client device.

9. A system as recited in claim 1, wherein said communicating comprises communicating the notification separately and independently from data of the media flow.

10. A computer-implemented method, comprising:
receiving a notification of a request to initiate a communication session between a client device and an endpoint device;
applying one or more attributes of the request to one or more policies to determine that the communication session is permitted and that the communication session is to be recorded;
forming a notification that includes routing information for routing a media flow of the communication session to a recording service; and
communicating the notification to cause the client device and the endpoint device to route the media flow of the communication session to the recording service such that the media flow is recorded by the recording service.

11. A method as described in claim 10, wherein said receiving comprises receiving an application programming interface (API) that is populated with the one or more attributes, and wherein said forming comprises forming the notification using at least a portion of the API.

12. A method as described in claim 10, further comprising receiving the one or more policies from the recording service in response to a query to the recording service for communication policies.

13. A method as described in claim 10, further comprising receiving the one or more policies from the recording service as part of a policy update from the recording service.

14. A method as described in claim 10, further comprising:
mapping an address of the client device to a first address of the recording service, and wherein the routing information comprises the first address of the recording service such that media flow of the communication session is routed from the client device using the first address of the recording service; and
mapping an address of the endpoint device to a second address of the recording service, and wherein the routing information comprises the second address of the recording service such that media flow of the communication session is routed from the endpoint device using the second address of the recording service.

15. A method as described in claim 10, wherein said communicating comprises communicating the notification separately and independently from data of the media flow.

16. A system comprising:
a recording module configured to:
receive signaling information indicating a request to initiate a communication session between a client device and an endpoint device;
receive one or more policies from a remote recording service;
apply one or more attributes of the request to the one or more policies to determine that the communication session is permitted and that the communication session is to be recorded; and
form a notification that includes routing information for routing a media flow of the communication session to the recording service; and
a communication component configured to communicate the notification to cause the client device and the endpoint device to route the media flow of the communication session to the recording service such that the media flow is recordable by the recording service.

17. A system as described in claim 16, wherein the recording module is configured to receive the signaling information separately and independently from media data included in the media flow.

18. A system as described in claim 16, wherein the recording module is further configured to invoke the recording service to initiate recording of the communication session.

19. A system as described in claim 16, wherein the one or more policies comprise a communication permission and a recording permission, and wherein the recording module is configured to compare one or more of the attributes to the communication permission to determine that the communication session is permitted, and to compare one or more of the attributes to the recording permission to determine that the communication session is to be recorded.

20. A system as described in claim 16, wherein the recording module is further configured to form a different notification that indicates that a portion of the media flow received from the client device is to be routed to the endpoint device, and that a portion of the media flow received from the endpoint device is to be routed to the client device, and wherein the communication component is further configured to communicate the different notification to the recording service to cause the media flow received at the recording service to be routed between the client device and the endpoint device.
